(19) United States
(12) Patent Application Publication
(10) Pub. No.: US 2012/0204565 A1
(43) Pub. Date: Aug. 16, 2012

(54) Natural Convection Intercooler

(75) Inventor: Alec Brooks, Pasadena, CA (US)

(73) Assignee: GOOGLE INC., Mountain View, CA (US)

(21) Appl. No.: 13/028,154

(22) Filed: Feb. 15, 2011

(51) Int. Cl. F03G 6/00

(52) U.S. Cl. 60/641.15

(57) ABSTRACT

A system includes a multi-stage compression engine including at least a first compressor and a second compressor and an intercooler positioned between the first compressor and the second compressor. The intercooler includes an air inlet configured to receive heated air from the first compressor and direct the heated air to a heat exchanger. The heat exchanger is configured to receive the heated air and to expel cooled air, wherein a cooling fluid is directed through the heat exchanger. An air outlet is configured to receive the cooled air and direct the cooled air to the second compressor. A chimney is positioned above the heat exchanger and adapted to capture the cooling fluid that is heated after having passed through the heat exchanger. A natural convection created in the chimney by the captured heated cooling fluid tends to draw the cooling fluid through the heat exchanger.

### TECHNICAL FIELD

This specification relates to power generation, and more specifically to power generation using turbine engines.

### BACKGROUND

Intercoolers are heat exchangers that are generally used in association with the compression of air or other compressible fluid. Intercoolers are commonly used in turbocharged automotive applications in which ambient air is compressed (to increase the amount of oxygen per cubic centimeter) before the air is provided to the engine. Compressing the air, however, causes the air become heated and less dense than cooler air at the same pressure. This heating can be at least partly offset by passing the heated, compressed air through an intercooler. As such, the compressed air is cooled and becomes denser.

Heliostats can be used to collect radiation from the Sun. Specifically, a heliostat can include one or more mirrors to direct solar rays toward a receiver mounted on a receiver tower. Some types of heliostats are capable of moving their one or more reflective surfaces, i.e., mirrors, as the Sun moves across the sky, both throughout the day and over the course of the year, in order to more efficiently direct solar rays to the receiver. Solar rays that are directed to the receiver can then be used to generate solar power. A field of heliostats can be placed surrounding one or more receivers to increase the quantity of radiation collected and optimize the amount of solar power that is generated. The solar power can be converted to electricity by a heat engine that is coupled to the receiver.

### SUMMARY

In general, one innovative aspect of the subject matter described in this specification can be embodied in a system as follows. The system includes a multi-stage compression Brayton-cycle engine including at least a first compressor and a second compressor and an intercooler positioned between the first compressor and the second compressor. The intercooler includes an air inlet configured to receive heated air from the first compressor and direct the heated air to a heat exchanger configured to receive the heated air and to expel cooled air. A cooling fluid is directed through the heat exchanger. An air outlet is configured to receive the cooled air and direct the cooled air to the second compressor. A chimney is positioned above the heat exchanger and adapted to capture the cooling fluid that is heated after having passed through the heat exchanger, wherein a natural convection created in the chimney by the captured heated cooling fluid tends to draw the cooling fluid through the heat exchanger.

These and other embodiments can each optionally include one or more of the following features. The intercooler can also include a fan configured to direct the cooling air fluid through the heat exchanger, wherein power consumed by the fan varies based on the natural convection created in the chimney, such that power consumed during an operation phase of the intercooler is less than during a start-up phase of the intercooler. The fan can be selectively controllable to minimize power consumed by the fan when the natural convection in the chimney is drawing cooling fluid through the heat exchanger at a rate exceeding a threshold rate. The intercooler can also include a controller configured to selectively turn on the fan during time periods when the natural convection is not drawing the cooling fluid through the heat exchanger at or above a threshold rate, and selectively turn off the fan during time periods when the natural convection is drawing the cooling fluid through the heat exchanger at or above the threshold rate. The intercooler can also include a controller configured to, receive information about temperature in the chimney, and based on the received information selectively turn on the fan during time periods when a temperature in the chimney is below a threshold level, and selectively turn off the fan during time periods when the temperature in the chimney is at or above the threshold level.

The engine can also include a first turbine coupled to the first compressor, a second turbine coupled to the second compressor, wherein air exiting the second compressor is heated and directed to the second turbine and air exiting the second turbine is directed to the first turbine. The system can also include a generator module coupled to the engine, the generator module including a first generator coupled to the first compressor and the first turbine. The first turbine can provide mechanical energy to the first compressor and the first generator. The generator module can further include a second generator coupled to the second compressor and the second turbine, wherein the second turbine provides mechanical energy to the second compressor and the second generator.

Another innovative aspect of the subject matter described in this specification can be embodied in a system as follows. The system includes a receiver tower including a tower adapted to be positioned in proximity to multiple heliostats and including a receiver mounted on the receiver tower configured to receive solar rays directed to the receiver from the heliostats. The receiver tower includes a chimney extending substantially a length of the receiver tower and an exhaust outlet at an upper end of the chimney. A multi-stage compression Brayton-cycle engine is coupled to the receiver tower. The engine includes a first compressor, a second compressor and an intercooler positioned between the first compressor and the second compressor, a first turbine and a second turbine. The intercooler includes an air inlet configured to receive heated air from the first compressor and direct the heated air to a heat exchanger. The heat exchanger is configured to receive the heated air and to expel cooled air, wherein a cooling fluid is directed through the heat exchanger. An air outlet is configured to receive the cooled air and direct the cooled air to the second compressor. The chimney included in the receiver tower is positioned above the heat exchanger and adapted to capture the cooling fluid that is heated after having passed through the heat exchanger. A natural convection created in the chimney by the captured heated cooling fluid tends to draw the cooling fluid through the heat exchanger and the heated cooling fluid is expelled through the exhaust outlet. Air from the Brayton-cycle engine is heated by solar energy from the receiver before entering at least one or both of the first turbine and the second turbine.

These and other embodiments can each optionally include one or more of the following features. The chimney can include a conduit formed inside the receiver tower. In other embodiments, the chimney can include a conduit attached to an exterior surface of a vertical member to which the receiver is mounted. The method can also include selectively operating a fan during time periods when the natural convection is not drawing the cooling fluid through the heat exchanger at or above a threshold rate, and selectively turning off the fan during time periods when the natural convection is drawing the cooling fluid through the heat exchanger at or above the threshold rate. The method can also include monitoring a temperature of the cooling fluid in the chimney, and based on the temperature, selectively operating or turning off the fan. The multi-stage compression engine can be a Brayton-cycle engine. The first compressor can be coupled to a first turbine, and the method can also include directing air expelled from the heat exchanger into a second compressor that is coupled to a second turbine, directing air exiting the second compressor into the second turbine, and directing air exiting the second turbine into the first turbine. At least one of the air directed into the first turbine or the air directed into the second turbine can be preheated by solar heat received from a receiver adapted to receiver solar rays from a plurality of heliostats before being directed into the respective second turbine.

Another innovative aspect of the subject matter described in this specification can be embodied in a system as follows. The system includes a multi-stage compression engine including at least a first compressor and a second compressor and an intercooler positioned between the first compressor and the second compressor. The intercooler includes an air inlet configured to receive heated air from the first compressor and direct the heated air to a heat exchanger. The heat exchanger is configured to receive the heated air and to expel cooled air, wherein a cooling fluid is directed through the heat exchanger. An air outlet is configured to receive the cooled air and direct the cooled air to the second compressor. A chimney is positioned above the heat exchanger and adapted to capture the cooling fluid that is heated after having passed through the heat exchanger, wherein a natural convection created in the chimney by the captured heated cooling fluid tends to draw the cooling fluid through the heat exchanger.

These and other embodiments can each optionally include the following feature. The multi-stage compression engine can include a reciprocating engine with turbo-charging.

Another innovative aspect of the subject matter described in this specification can be embodied in a method as follows. The method for intercooling includes receiving heated air from a first compressor in a multi-stage compression engine and directing the heated air to a heat exchanger, cooling the heated air in the heat exchanger with a cooling fluid, and providing a chimney positioned above the heat exchanger and adapted to capture the cooling fluid that is heated after having passed through the heat exchanger. A natural convection created in the chimney by the captured heated cooling fluid tends to draw the cooling fluid through the heat exchanger.

Particular embodiments of the subject matter described in this specification can be implemented so as to realize one or more of the following advantages. The efficiency of a multi-stage compression power generation system can be increased by cooling the compressed air between compression stages. The overall efficiency of a power generation system can be increased by taking advantage of naturally occurring convective flows to substantially reduce or eliminate the need for power-consuming fans or blowers to direct a cooling fluid through an intercooler. A solar energy receiver tower can serve not only to support an elevated solar receiver, but also as a chimney to enhance the convective flow of cooling air across a heat exchanger.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 illustrates an example intercooler that can be used to cool a working fluid in a multi-stage compression engine.

FIG. 2 is a block diagram of an illustrative example two-stage generator system.

FIG. 3 illustrates an example convective flow of air across an intercooler.

FIGS. 4A-4C illustrate example cooling towers for convective intercooling.

FIGS. 5A and 5B illustrate an example solar receiver towers and power generation systems that implement convective cooling.

Like reference numbers and designations in the various drawings indicate like elements.

### DETAILED DESCRIPTION

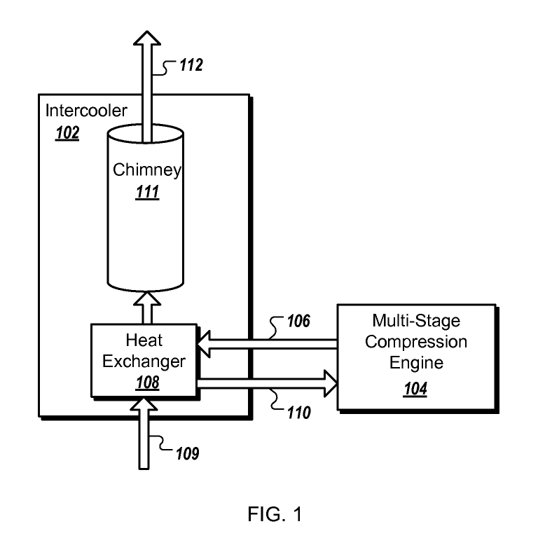

Referring to FIG. 1, an intercooler 102 is described that can be used, for example, to cool a working fluid in a multi-stage compression engine 104. In some implementations, the engine is a multi-stage compression Brayton-cycle engine. In some implementations, the engine is a turbocharged reciprocating engine. For example, large diesel engines can include turbochargers and intercoolers. The engine includes at least a first compressor and a second compressor with the intercooler positioned at a flow path there between. The intercooler 102 includes an air inlet 106 configured to receive heated gas, which in an illustrative example is air, from the first compressor and to direct the heated air to a heat exchanger 108. A cooling fluid, such as air, is directed through the heat exchanger 108 through one or more cooling inlets, e.g., inlet 109, which is configured to receive the heated air and to expel cooled air. An air outlet 110 is configured to receive the cooled air and direct the cooled air to the second compressor. The intercooler 102 further includes a chimney 110 positioned above the heat exchanger 108 and adapted to capture the cooling fluid that is heated after having passed through the heat exchanger 108. A natural convection created in the chimney 110 by the captured heated cooling fluid tends to draw the cooling fluid through the heat exchanger. The chimney 110 can include an outlet 112 near an upper end, for example, to exhaust or otherwise redirect the heated cooling fluid. Positioning the chimney 110 above the heat exchanger 108 allows convection to draw the cooling fluid through the heat exchanger without using, or by reducing the use of, a fan or blower. Power consumed by the intercooler 102 can thereby be reduced, increasing the net power output of the system.

Generally speaking, when air or another compressible fluid is compressed, the air becomes heated. Since hot air takes more power to compress than cool air, efficiency can be gained by cooling the hot air prior to further compression of the air. The hot compressed air can be cooled by an air-to-air, air-to-liquid, or other appropriate form of intercooler, in which thermal energy of the hot compressed air is transferred to ambient air or other fluid thereby cooling the compressed air prior to being compressed further. In typical applications, cooling air is forcibly blown or liquid is forcibly pumped across a heat exchanger in order to increase the thermal differential between the heat exchanger and the cooling fluid and therefore increase the amount of cooling provided to the compressed air. Forcibly blowing or pumping coolant, however, consumes energy and reduces the overall efficiency of the power generation process.

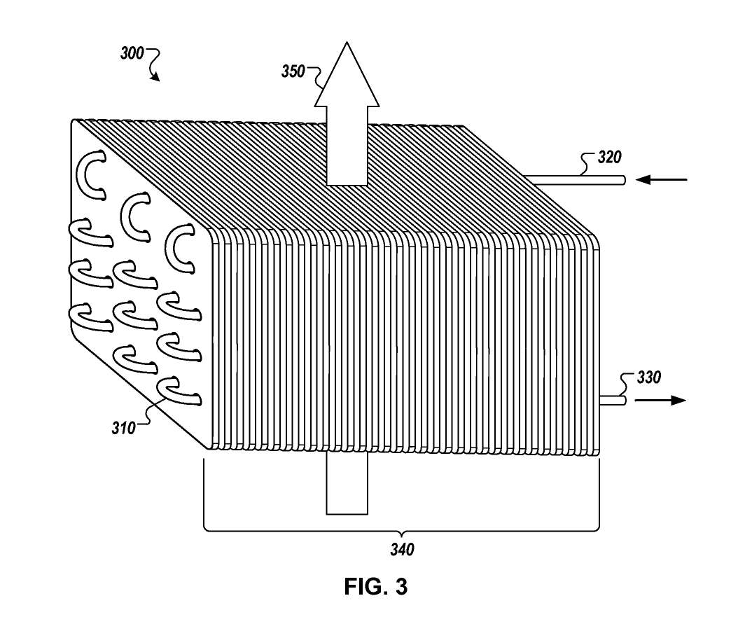

As will be discussed further in the descriptions of FIGS. 3, 4A-4C, and 5, the intercooler described herein at least partly relies on convection to move the cooling fluid through a heat exchanger included in the intercooler. As described above in reference to FIG. 1, the intercooler includes a chimney. As the hot pressurized air loses heat to the ambient air (i.e., the cooling fluid) surrounding the heat exchanger, the surrounding air becomes warm and rises, thereby creating a convective air flow that will carry heat energy away from the intercooler and draw additional cool air across the intercooler.

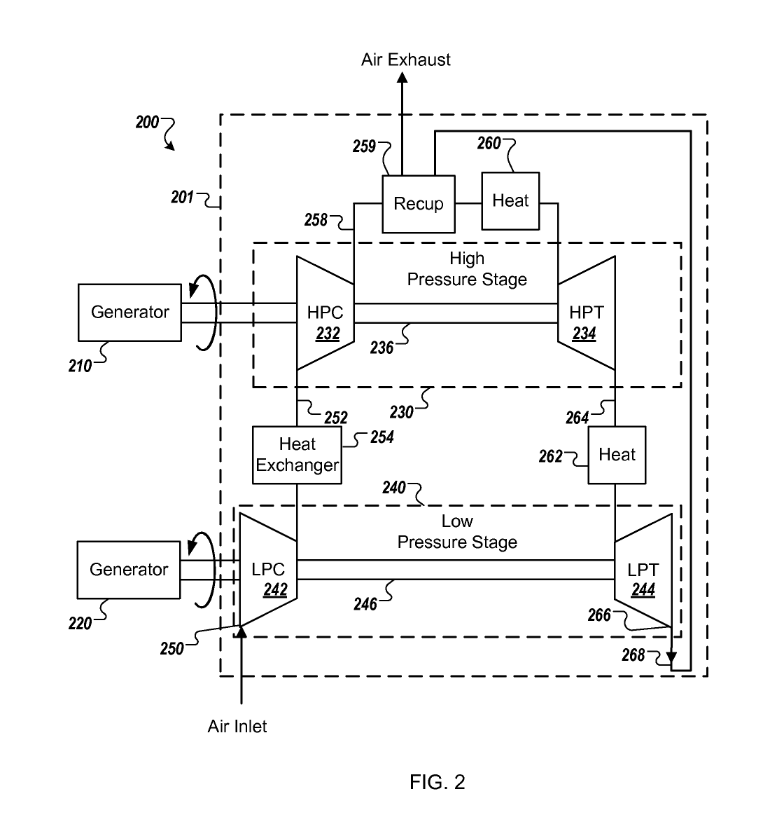

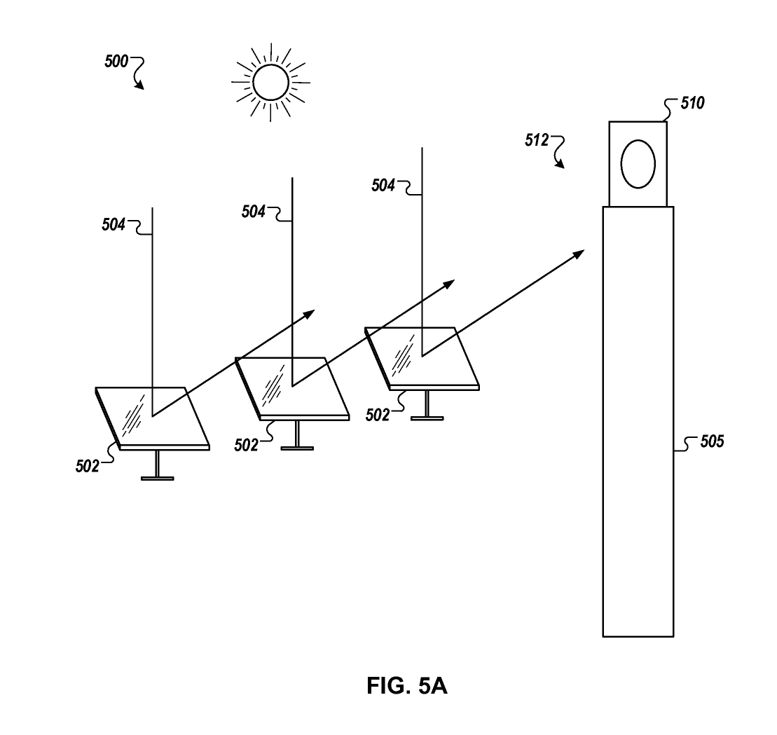

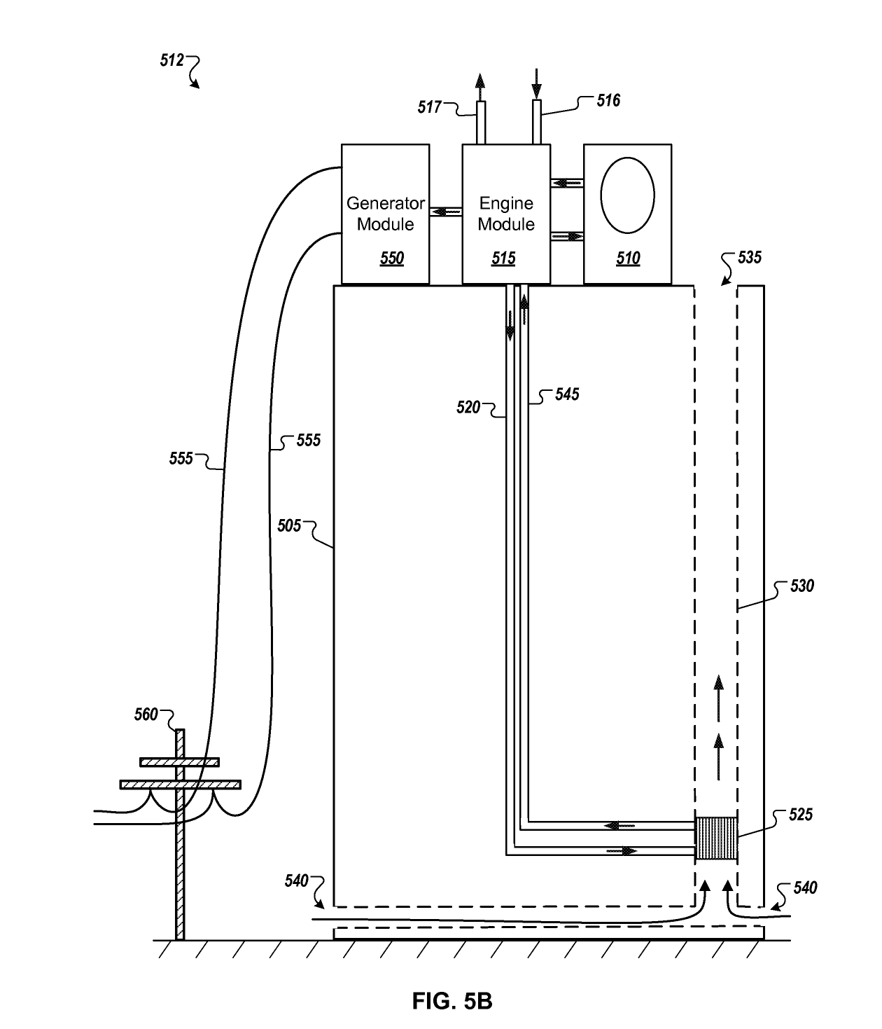

FIG. 2 is a block diagram of an illustrative example of a two-stage generator system 200. The two-stage generator system includes a multi-stage compression engine 201. The multi-stage compression engine 201 is a Brayton cycle engine, and is an example of an engine that can be used as engine 104 in FIG. 1. In some implementations, the two-stage generator system 200 may receive heat energy from a heliostat field, which is described further below in reference to FIGS. 5A and 5B.

In the illustrated example, a generator 210 is coupled to a high pressure stage 230 of an engine 201. The high pressure stage 230 includes a high pressure compressor 232 and a high pressure turbine 234 coupled to each other and to the generator 210 by a rotatable shaft 236. A generator 220 is coupled to a low pressure stage 240. In some implementations, the output pressure of the high pressure stage 230 can be about 2.5 to 5 times the output pressure of the low pressure stage 240. The low pressure stage 240 includes a low pressure compressor 242 and a low pressure turbine 244 coupled to each other and to the generator 220 by a rotatable shaft 246. In some implementations, the low pressure stage 240 and the high pressure stage 230 may each be configured as Brayton cycle engines as shown. While the present example is illustrated and described as having two stages, in some implementations any practical number of stages may be used. For example, three, four, five, ten, or more Brayton engines may be staged as described herein.

In the illustrated example, ambient or otherwise substantially unpressurized air is drawn into the low pressure compressor 242 through an air inlet 250. The air pressure is increased by the low pressure compressor 242, and is heated as a by-product of the pressurization by the low pressure compressor 242. The low pressure air is then provided to a heat exchanger 254 through a low pressure conduit 252. The heated low pressure air is passed through the heat exchanger 254 to remove a portion of the heat from the air passing through the low pressure conduit 252. In some implementations, the heat exchanger 254 can transfer at least a portion of the heat energy in the low pressure compressed air to a flow of ambient air passing through or across the heat exchanger 254.

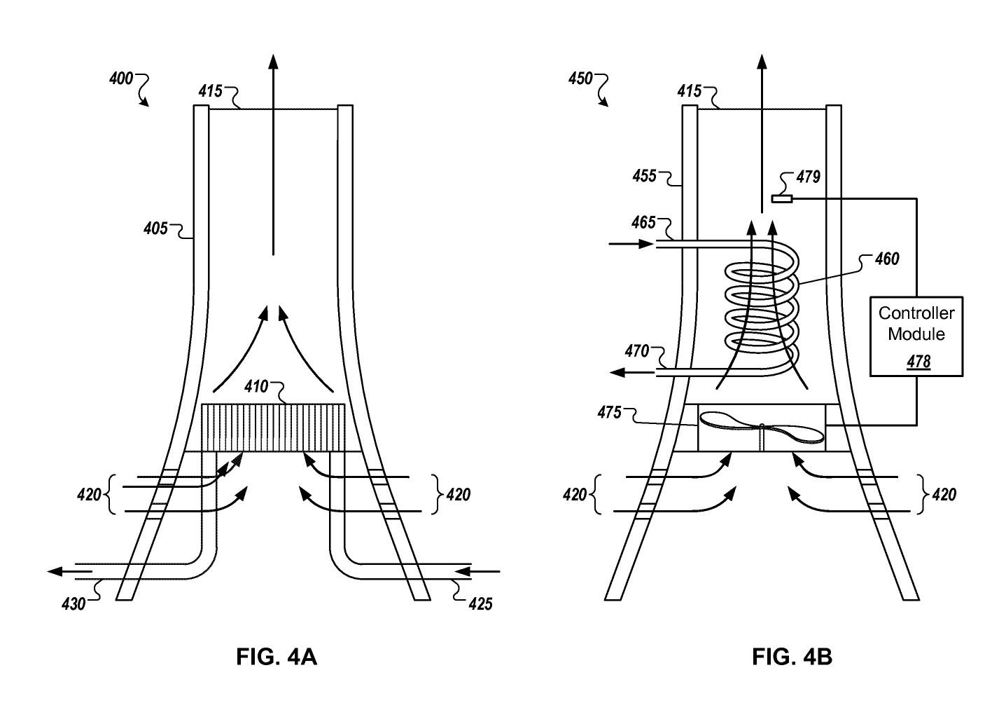

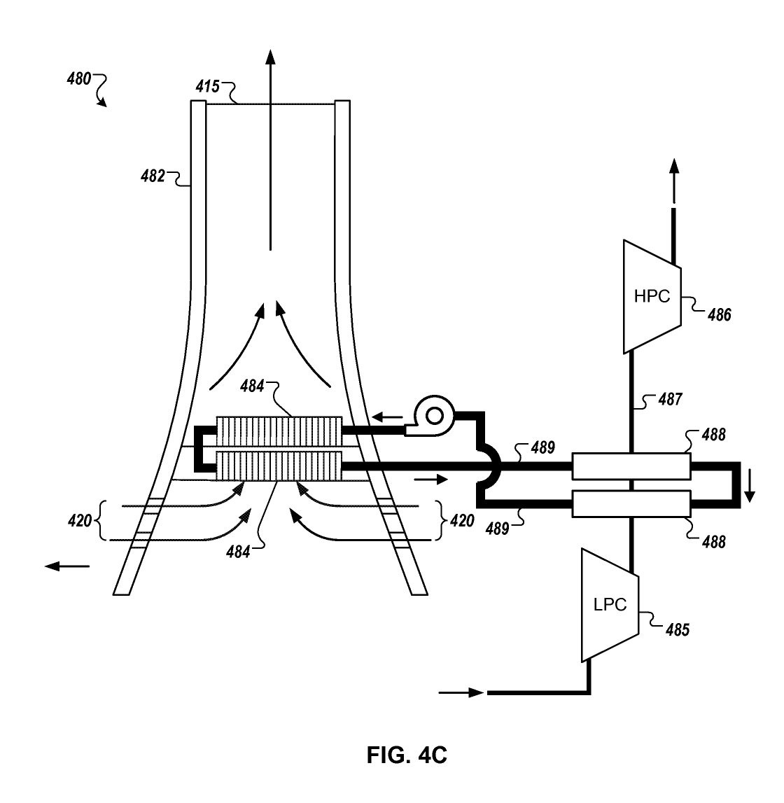

As will be discussed further in the description of FIG. 3, the heat exchanger 254 may be cooled through convection wherein the heat given off by the heat exchanger 254 can induce a convective flow of cool ambient air across and/or through the heat exchanger 254. In some implementations, the heat exchanger 254 may be located in a cooling tower that is configured to enhance the convective flow of cooling air. Examples of such cooling towers are discussed in the descriptions of FIGS. 4A-4C and FIG. 5.

While the illustrated example shows the use of a Brayton type of engine, other types of engines can also benefit from convectively cooled heat exchangers. In some implementations, multi-stage compression can be performed for other types of engines, such as turbocharged reciprocating engines. For example, turbocharged gasoline or diesel internal combustion engines can include one or more heat exchangers, such as the heat exchanger 254, that can be used to convectively cool air that has been pressurized by a turbocharger or supercharger.

The intercooled air is pressurized further by the high pressure compressor 232. The high pressure air is provided to a heat recuperation unit 259 through a high pressure conduit 258. The heat recuperation unit 259 is a heat exchanger configured to transfer heat energy from exhaust air (which is described below) to the high pressure air.

The high pressure air is also provided to a heat source 260. In some implementations, the heat source 260 can be a solar energy collection point wherein one or more solar heliostats may reflect and concentrate solar energy onto a receiver configured to heat the high pressure air. In some implementations, the heat source 260 can be any appropriate source of heat energy that can be used to heat the high pressure air. For example, the heat source 260 can obtain heat energy from sources such as geothermal energy, nuclear power, combustion, or other appropriate energy source.

The heated, high pressure air is provided to the high pressure turbine 234 where it is allowed to expand. The expansion of the air through the high pressure turbine 234 urges the high pressure turbine 234 to rotate. The rotation of the high pressure turbine 234 urges rotation of the shaft 236, which in turn rotates the high pressure compressor 232 thereby causing the pressurization of the low pressure air entering the high pressure stage 230. The rotation of the shaft 236 also drives the generator 210 to generate electric power.

In some implementations, the generator 210 may be omitted. For example, the high pressure turbine 234 can drive the high pressure compressor 232 alone. In some implementations, the high pressure compressor 232 can be omitted. For example, the high pressure turbine 244 can drive the generator 210 alone.

Through expansion in the high pressure turbine 234, some of the thermal energy of the air is lost. The expanded air is then provided to a heat source 262 through a conduit 264. The heat source 262 reheats the air flowing through the conduit 264. In some implementations, the heat source 262 may be substantially similar to the heat source 260. In some implementations, the heat source 260 and 262 may share a common heat source. For example, a heliostat field may concentrate solar energy on a receiver that provides both the heat source 260 and the heat source 262.

The reheated air is provided to the low pressure turbine 244 where the air is allowed to expand. The expansion of the air through the low pressure turbine 244 urges the low pressure turbine 244 to rotate. The rotation of the low pressure turbine 244 urges rotation of the shaft 246, which in turn rotates the low pressure compressor 242. The rotation of the low pressure compressor 242 causes the pressurization of the air entering the low pressure compressor 242 through the inlet 250. The rotation of the shaft 246 also drives the generator 220 to generate electric power. In some implementations, the generator 220 may be omitted. For example, the low pressure turbine 244 can drive the low pressure compressor 242 alone. In some implementations, the low pressure compressor 242 can be omitted. For example, the low pressure turbine 244 can drive the generator 220 alone.

The air expanded through the low pressure turbine 244 is then provided to the heat recuperation unit 259 through a conduit 268. At the heat recuperation unit 259, heat energy from the air exiting the low pressure turbine 244 can be at least partly recovered and provided back to preheat the air prior to entering the heat source 260. Once the exiting air passes through the heat recuperation unit 259, the exiting air can be exhausted.

FIG. 3 illustrates an example convective flow of air across a heat exchanger 300. The heat exchanger 300 includes a fluid conduit 310, through which hot compressed air flows. The hot air enters an inlet 320, circulates through the fluid conduit 310, and exits through an outlet 330. The fluid conduit 310 is in thermal communication with a number of fins 340 that are spaced apart such that air or other cooling fluid may flow over and/or between the fins 340. In some implementations, the fins 340 project from the conduit 310 (i.e., the fins add surface area to the conduit 310 but generally do not include fluid conduits themselves). In some implementations, the heat exchanger 300 may be configured as one or more channels formed in the fins 340 through which the compressed air may flow. Generally speaking, the heat exchanger 300 prevents mixing of the hot pressurized air and the cooling fluid that surrounds the intercooler 300, and increases the surface area between the compressed air and the ambient cooling fluid through which heat energy can be transferred.

Heat energy from the hot pressurized air is transferred to the walls of the fluid conduit 310, and in turn, to the fins 340 thereby warming the fins and cooling the hot pressurized air before the pressurized air exits through the outlet 330. The fins 340 increase the amount of surface area across which the heat energy can be distributed though conduction. The cooling fluid (e.g., air) surrounding the heat exchanger 300 passes through the spaces between the fins 340 and comes into contact with the surface areas of the fins 340 that have been heated by the heat energy obtained from the hot pressurized air.

Heat energy radiating from the fins 340 warms the cooling fluid. The warmed cooling fluid becomes less dense and therefore relatively more buoyant than the surrounding cooling fluid. The reduced density of the warmed cooling fluid above the heat exchanger 300 results in a pressure gradient across the heat exchanger 300 due to the reduced hydrostatic head of the lower density fluid compared to the non-heated surrounding fluid. This pressure gradient causes a convective flow 350 upward through the heat exchanger 300. A chimney increases the height of the column of lower-density fluid which correspondingly increases the pressure that drives the flow through the heat exchanger 300. In this general manner, the hot pressurized air flowing through the heat exchanger 300 is cooled by the convective flow 350 of cooling fluid, substantially or entirely without actively pumping or blowing the cooling fluid across the fins 340.

The heat exchanger 300 can be placed within or near the base of a cooling tower or chimney. For example, a chimney such as the chimney 111 of FIG. 1 may be positioned above the heat exchanger 300 and adapted to capture the cooling fluid that is heated after having passed through the heat exchanger 300, wherein the convective flow 350 is at least partly insulated by the walls of the chimney so as to substantially maintain the relative buoyancy of the cooling fluid, thereby enhancing the convective flow 350 and/or to prevent mixing of the warmed and ambient cooling fluid. In some implementations, heat from the warmed cooling fluid may heat the walls of the chimney, creating a thermal mass that can exchange heat energy with the cooling fluid and at least partly stabilize the convective flow 350. Some examples of cooling towers that can be used in conjunction with intercoolers are discussed next in the descriptions of FIGS. 4A-4C.

FIGS. 4A-4C illustrate example intercoolers for convective intercooling. Referring to FIG. 4A, an example intercooler 400 is shown. The intercooler 400 includes a chimney 405 and a heat exchanger 410. In some implementations, the heat exchanger 410 can be the heat exchanger 108 of FIG. 1. The chimney 405 includes an air outlet 415 near the upper end, and a collection of air inlets 420 below the heat exchanger 410.

Hot compressed air flows into an inlet 425, through the heat exchanger 410, and out an outlet 430. In other implementations, the inlet 425 and outlet 430 can be located at different positions, and the locations shown are but one example. As the hot compressed air flows through the heat exchanger 410, heat energy is transferred from the hot air to the relatively cooler fins of the heat exchanger 410 (e.g., the fins 340 of the intercooler 300 shown in FIG. 3). Air within the chimney 405 is heated by the fins of the heat exchanger 410.

The reduced density of the fluid warmed by the heat exchanger 410 causes a pressure gradient across the heat exchanger 410 due to the reduced hydrostatic head of the lower density fluid compared to the non-heated surrounding fluid. This pressure gradient causes a flow upward through the heat exchanger 410 toward the air outlet 415. Heat energy obtained from the heat exchanger 410 warms the cool air and energizes the continued convective flow of air across the heat exchanger 410, which cools the compressed air as it flows from the air inlet 425 to the air outlet 430.

Referring now to FIG. 4B, an example intercooler 450 is shown. The intercooler 450 includes a chimney 455 that is substantially similar to the chimney 405. The intercooler 450 includes a heat exchanger 460 that includes an air inlet 465 and an air outlet 470. In the illustrated example, the heat exchanger 460 is shown as a coil, but in other embodiments the coil can be replaced by a finned, radiator-style heat exchanger such as the heat exchanger 300 of FIG. 3.

The intercooler 450 also includes a blower 475 controlled by a controller module 478. The blower 475 is configured to draw outside air into the chimney 455 through the air inlets 420, across and/or through the intercooler 455, and out the air outlet 415. In some implementations, the controller module 478 can be configured to receive information about the temperature drop of the compressed air being passed through the intercooler 455. For example, temperature sensors can sense the temperature of the pressurized air as it enters the intercooler 455 and at it exits, and compare the difference to determine the temperature drop that occurs in the intercooler 455. Based on this temperature drop, the controller module 478 can controllably vary the speed of the blower 475 to alter the cooling effect of the intercooler 455 and thereby control the temperature drop.

In some implementations, the controller module 478 can be configured to receive information about temperature in the chimney 455 from a sensor 479, and based on the received information selectively turn on the blower 475 during time periods when a temperature in the chimney 455 is below a threshold temperature, and selectively vary the speed or shut off the blower 475 during time periods when the temperature in the chimney 455 is at or above the threshold temperature. Based on the sensed temperature, operating conditions within the chimney 415, and in particular the state of the convective flow, can be estimated. When the convective flow is estimated to be self-sustaining, i.e., sufficient to draw the cooling air across the heat exchanger 455 without the aid of the blower 475, the blower can turned off and power thereby saved.

In some implementations, the sensor 479 can be a flow sensor, and the controller module 478 can selectively turn on the blower 475 during time periods when the sensed natural convection flow rate is not drawing the cooling fluid through the heat exchanger 460 at or above a threshold rate, and selectively turn off the blower 475 during time periods when the sensed natural convection flow rate is drawing the cooling fluid through the heat exchanger 460 at or above the threshold rate. For example, the blower 475 may be operated at high power during a start-up phase of the heat exchanger 460, and once a rate of convective flow is sensed to have exceeded a threshold rate, power to the blower 475 can be reduced. In some implementations, the blower 475 can be controllably operated to boost the convective flow of air caused by the heat given off by the heat exchanger 460. For example, the speed of the blower 475 can be adjusted by a fan speed controller to substantially maintain a predetermined minimum temperature drop in the compressed air as the air flows between the air inlet 465 and the air outlet 470.

Referring now to FIG. 4C, an example intercooler 480 is shown. The intercooler 480 includes a chimney 482 and a heat exchanger 484. In the illustrated example, the heat exchanger 484 can be a liquid (e.g., water, glycol, oil) to air heat exchanger, or an air (or other appropriates gaseous fluid) to air heat exchanger.

A low pressure compressor 485 compresses, and thus heats, air before the air is provided to a high pressure compressor 486 for additional compression through a conduit 487. The conduit 487 intersects a heat exchanger 488 where heat energy from the compressed air is at least partly transferred to air, water, or other appropriate fluid flowing through the heat exchanger 488 and through a fluid circuit 489. A pump 490 drives the flow of fluid through the heat exchanger 484, the heat exchanger 488 and the fluid circuit 489. In implementations in which air or other appropriate gaseous fluid is used within the fluid circuit 489, the pump 490 can be replaced by a blower.

In operation, heat energy is at least partly transferred from the compressed air, through the heat exchanger 488, to the fluid in the fluid circuit 489, thus warming the fluid and cooling the compressed air. The pump 490 drives the fluid warmed by the heat exchanger 488 to the heat exchanger 484. Heat energy from the fluid is transferred through the heat exchanger 484 to the air within the chimney 482, thus warming the air and cooling the fluid. The heat energy transferred to the air causes the air to flow convectively out the air outlet 415, which draws in additional cool air through the air inlets 420.

The cooled fluid circulates through the fluid circuit 489, back to the heat exchanger 488 to provide additional cooling for the compressed air. In some implementations, the fluid circuit 489 can permit the compressors 486 and 487, and the conduit 487 to be located remotely from the intercooler 480. For example, keeping the length of the conduit 487 as short as possible can advantageously minimize pressure losses that could occur over longer distances, and thereby enhance the overall efficiency of the two-stage compression performed by the compressors 485 and 486. By using a secondary fluid to transport heat energy from the heat exchanger 488 to the heat exchanger 484, the compressors 485 and 496 can be located remotely from the chimney 482, while keeping the length of the conduit 487 relatively short. Although in this example, a two cross-flow heat exchanger is illustrated, in some embodiments multiple cross flow heat exchangers can be used to increase the amount of heat energy transferred out of the pressurized air, and to increase the temperature and buoyancy difference that drives the convective flow.

In some embodiments, the chimneys 405, 455, and 482 can be hyperboloid towers, tubular chimneys, or other appropriate structures for enhancing the natural flow of warm air across and/or through the intercooler 410. In some embodiments, the intercoolers 410, 460, and 484 may be cooled by water or other liquid. For example, the intercooler 410 may be submerged in a cooling pond of water. As the intercooler 410 warms the water, a convective flow will occur. In some implementations, the chimneys 405, 455, and 482 can be replaced by liquid conduits. For example, the intercooler 410 may be located within a vertically oriented pipe submerged in a cooling pond. As such, a convective flow of water through the vertical pipe may be used to draw deeper, and therefore cooler, water in through a lower inlet of the pipe and provide that cool water to reduce the temperature of the intercooler 410. In some embodiments, the chimneys 405, 455, and 482 can be a conduit within a solar receiver tower such as the receiver tower. An example of such a conduit is discussed in the description of FIG. 5B.

FIGS. 5A and 5B illustrate an example power generation system 512 that implements convective cooling. FIG. 5A illustrates an example heliostat field 500 for use in power generation. A number of heliostats 502 are assigned to direct solar rays 504 toward a receiver 510 that is typically mounted on a receiver tower 505. The solar rays 504 directed toward the receiver 510 can heat a working fluid within the receiver 510. The heated working fluid can be provided to a generator system to generate electrical power. In some implementations, the working fluid may go through multiple stages of compression before it is heated by the solar rays 504 directed to the receiver 510. For example, the solar rays 504 may be used to heat air in a multi-stage Brayton cycle engine generator system, in which air is compressed two or more times prior to solar or other heating. For example, the solar rays 504 may be used to heat the heat sources 260 and 262 of the two-stage generator system 200 of FIG. 2.

Referring now to FIG. 5B, the system 512 includes the receiver tower 505. Configured substantially atop the receiver tower 505 is the receiver 510. In some implementations, the receiver 510 can be configured to collect the solar rays 504 reflected by the heliostats 502, and use the collected solar rays 504 to heat air used to power a generator system, such as the two-stage generator system 200 of FIG. 2.

An engine module 515 draws cool outside air in through an inlet 516 to be compressed by a low pressure compressor (e.g., the low pressure compressor 242). A side effect of the compression process is that the compressed air is also heated. The heated, compressed air is passed through a conduit 520 to a heat exchanger 525. In some implementations, the heat exchanger 525 can be the heat exchanger 254 of FIG. 2. The heat exchanger 525 is located at the lower end of a conduit 530 within the receiver tower 505. In some embodiments, the conduit 530 may be within a chimney or other form of conduit that is attached to an exterior surface of the receiver tower 505. In other embodiments, the conduit 530 can be within a chimney formed separately from the receiver tower 505, although fluidically coupled to the engine module 515.

Heat from the compressed air is passed by the heat exchanger 525 to a cooling fluid, which in this example is ambient air that is drawn into the conduit 530 at inlets 540. As the ambient air is warmed, the ambient air is captured by the conduit 530 that is positioned above the heat exchanger 525 and convectively rises up the conduit 530 and can escape through an outlet 535. The convective flow causes additional ambient air to be drawn into the conduit 530 through a collection of inlets 540. The convective flow of the cooling fluid across the heat exchanger 525 cools the compressed air that is directed through the heat exchanger 525, and the cooled compressed air is returned to the engine module 515 through a conduit 545. The cooled air is compressed by a high pressure compressor (e.g., the high pressure compressor 232). The conduits 520 and 545 can be attached to the exterior surface of the receiver tower 505, although in other implementations they can be formed within the receiver tower. In some implementations, the conduits 520 and 545 can be conduits of an intermediate cooling fluid, such as that previously discussed in the description of FIG. 4C.

The pressurized air is passed to the receiver 510, where the compressed air is heated by the collected solar rays. The heated, compressed air is returned to the engine module 515 where the air is allowed to expand through a high pressure turbine (e.g., the high pressure turbine 234). The high pressure turbine turns a shaft that drives a generator (e.g., the generator 210) in a generator module 550.

The expanded air can be provided to the receiver 510 to be heated again. The reheated air is returned to the engine module 515 where the reheated air is allowed to expand through a low pressure turbine (e.g., the low pressure turbine 244). The low pressure turbine also turns a shaft that drives the aforementioned generator, or another generator (e.g., the generator 220). Heat energy in the expanded air can be recovered by a heat recuperation unit (e.g., the heat recuperation unit 259) before being exhausted to atmosphere through an exhaust 517. Power produced by the generator(s) can be provided by a set of wires 555 (or otherwise) to an electric utility grid 560 for transport and distribution, or otherwise consumed, stored or distributed.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A system comprising:
a receiver tower comprising a tower adapted to be positioned in proximity to a plurality of heliostats and including a receiver mounted on the receiver tower configured to receive solar rays directed to the receiver from the plurality of heliostats, the receiver tower including a chimney extending substantially a length of the receiver tower and an exhaust outlet at an upper end of the chimney; and
a multi-stage compression engine coupled to the receiver tower, the engine including a first compressor, a second compressor and an intercooler positioned between the first compressor and the second compressor, a first turbine and a second turbine, wherein the intercooler comprises:
an air inlet configured to receive heated air from the first compressor and direct the heated air to a heat exchanger;
the heat exchanger configured to received the heated air and to expel cooled air, wherein a cooling fluid is directed through the heat exchanger;
an air outlet configured to receive the cooled air and direct the cooled air to the second compressor; and
wherein:
the chimney included in the receiver tower is positioned above the heat exchanger and adapted to capture the cooling fluid that is heated after having passed through the heat exchanger, wherein a natural convection created in the chimney by the captured heated cooling fluid tends to draw the cooling fluid through the heat exchanger and the heated cooling fluid is expelled through the exhaust outlet; and
air from the engine is heated by solar energy from the receiver before entering at least one or both of the first turbine and the second turbine.

2. The system of claim 1, wherein the chimney comprises a conduit formed inside the receiver tower.

3. The system of claim 1, wherein the chimney comprises a conduit attached to an exterior surface of a vertical member to which the receiver is mounted.

4. The system of claim 1, the intercooler further comprising a fan configured to direct the cooling air fluid through the heat exchanger;
wherein power consumed by the fan varies based on the natural convection created in the chimney, such that power consumed during an operation phase of the intercooler is less than during a start-up phase of the intercooler.

5. The system of claim 4, the intercooler further comprising a controller configured to:
receive information about temperature in the chimney;
based on the received information:
selectively turn on the fan during time periods when a temperature in the chimney is below a threshold level; and
selectively turn off the fan during time periods when the temperature in the chimney is at or above the threshold level.

6. A system comprising:
a multi-stage compression engine including at least a first compressor and a second compressor and an intercooler positioned between the first compressor and the second compressor, the intercooler comprising:
an air inlet configured to receive heated air from the first compressor and direct the heated air to a heat exchanger;
the heat exchanger configured to receive the heated air and to expel cooled air, wherein a cooling fluid is directed through the heat exchanger;
an air outlet configured to receive the cooled air and direct the cooled air to the second compressor; and
a chimney positioned above the heat exchanger and adapted to capture the cooling fluid that is heated after having passed through the heat exchanger, wherein a natural convection created in the chimney by the captured heated cooling fluid tends to draw the cooling fluid through the heat exchanger.

7. The system of claim 6, the intercooler further comprising a fan configured to direct the cooling air fluid through the heat exchanger;
wherein power consumed by the fan varies based on the natural convection created in the chimney, such that power consumed during an operation phase of the intercooler is less than during a start-up phase of the intercooler.

8. The system of claim 7, wherein the fan is selectively controllable to minimize power consumed by the fan when the natural convection in the chimney is drawing cooling fluid through the heat exchanger at a rate exceeding a threshold rate.

9. The system of claim 7, the intercooler further comprising a controller configured to:
selectively turn on the fan during time periods when the natural convection is not drawing the cooling fluid through the heat exchanger at or above a threshold rate; and
selectively turn off the fan during time periods when the natural convection is drawing the cooling fluid through the heat exchanger at or above the threshold rate.

10. The system of claim 7, the intercooler further comprising a controller configured to:
receive information about temperature in the chimney;
based on the received information:
selectively turn on the fan during time periods when a temperature in the chimney is below a threshold level; and
selectively turn off the fan during time periods when the temperature in the chimney is at or above the threshold level.

11. The system of claim 6, wherein the engine is a Brayton-cycle engine further comprising:
a first turbine coupled to the first compressor;
a second turbine coupled to the second compressor;
wherein:
air exiting the second compressor is heated and directed to the second turbine;
air exiting the second turbine is directed to the first turbine.

12. The system of claim 11, further comprising a generator module coupled to the engine, the generator module comprising:
a first generator coupled to the first compressor and the first turbine, wherein the first turbine provides mechanical energy to the first compressor and the first generator; and
a second generator coupled to the second compressor and the second turbine, wherein the second turbine provides mechanical energy to the second compressor and the second generator.

13. The system of claim 6, wherein the multi-stage compression engine comprises a reciprocating engine with turbo-charging.

14. A method for intercooling comprising:
receiving heated air from a first compressor in a multi-stage compression engine and directing the heated air to a heat exchanger;
cooling the heated air in the heat exchanger with a cooling fluid; and
providing a chimney positioned above the heat exchanger and adapted to capture the cooling fluid that is heated after having passed through the heat exchanger, wherein a natural convection created in the chimney by the captured heated cooling fluid tends to draw the cooling fluid through the heat exchanger.

15. The method of claim 14, further comprising:
selectively operating a fan adapted to draw the cooling fluid through the heat exchanger during time periods when the natural convection is not drawing the cooling fluid through the heat exchanger at or above a threshold rate; and
selectively turning off the fan during time periods when the natural convection is drawing the cooling fluid through the heat exchanger at or above the threshold rate.

16. The method of claim 15, further comprising:
monitoring a temperature of the cooling fluid in the chimney; and
based on the temperature, selectively operating or turning off the fan.

17. The method of claim 14, wherein the multi-stage compression engine comprises a Brayton-cycle engine.

18. The method of claim 14, wherein the first compressor is coupled to a first turbine, the method further comprising;
directing air expelled from the heat exchanger into a second compressor that is coupled to a second turbine;
directing air exiting the second compressor into the second turbine; and
directing air exiting the second turbine into the first turbine.

19. The method of claim 18, wherein at least one of the air directed into the first turbine or the air directed into the second turbine is preheated by solar heat received from a receiver adapted to receiver solar rays from a plurality of heliostats before being directed into the respective second turbine.
